(19) United States
(12) Patent Application Publication
(10) Pub. No.: US 2023/0400984 A1
(43) Pub. Date: Dec. 14, 2023

(54) VARIABLE SIZE RECORD STORAGE

(71) Applicant: Positioning Universal Inc., San Diego, CA (US)

(72) Inventor: Ryan C. Johnson, San Diego, CA (US)

(21) Appl. No.: 18/331,508

(22) Filed: Jun. 8, 2023

Related U.S. Application Data
(60) Provisional application No. 63/350,107, filed on Jun. 8, 2022.

(51) Int. Cl. G06F 3/06; G16Y 40/35

(52) U.S. Cl. CPC G06F 3/0611; G06F 3/0659; G06F 3/0679; G16Y 40/35

(57) ABSTRACT

Embodiments of the disclosure provide for managing data stored in memory of a device. Maintaining variable-sized data records in an Internet-of-Things (IoT) device can comprise receiving data for a new record to be stored in a memory of the IoT device and searching data frames stored in the memory of the IoT device. The data frames can be stored in the memory of the IoT device in a circular manner and each data frame can store therein a data record of variable size. Searching the data frames can comprise locating a head data frame and a tail data frame. Each data frame can be validated during the searching of the plurality of data frames. In response to locating a valid tail data frame, the data for the new record can be written into a new tail frame for the plurality of data frames.

### CROSS REFERENCE TO RELATED APPLICATIONS

The present application claims the benefits of and priority, under 35 U.S.C. § 119(e), to U.S. Provisional Application No. 63/350,107, filed Jun. 8, 2022, entitled “VARIABLE SIZE RECORD STORAGE” of which the entire disclosure of which is incorporated by reference for all purposes.

### FIELD OF THE DISCLOSURE

Embodiments of the present disclosure relate generally to methods and systems for managing data stored in memory of a device and more particularly to maintaining variable-sized data records in an Internet-of-Things (IoT) device.

### BACKGROUND

Internet-of-Things (IoT) devices are compact, wireless devices with sensors, processing ability, software, and other technologies that connect and exchange data with other devices and systems over the Internet or other communications networks. Such devices typically, collect data and transmit, perhaps periodically, this data a server or other, remote computing device. The collected data is maintained, at least until transmitted, if not longer, in the memory of the device. This memory is typically a flash memory such as a NAND flash, for example. Fault tolerance in such devices is typically achieved through a journaled file system. This approach requires multiple page erases, which is the most expense operation on a NAND-flash-based device, per record write and is hence too slow for IoT devices that require real-time storage speeds. Fault tolerance can also be achieved by calculating a Cyclic Redundancy Check (CRC) over records. However, this approach requires compute cycles, Random Access Memory (RAM) to calculate the CRC, and Read-Only Memory (ROM) space to store the CRC algorithm. Compute cycles, RAM and ROM are all limited on IoT devices. Hence, there is a need for improved methods and systems for maintaining data records in an IoT device.

### BRIEF SUMMARY

Embodiments of the disclosure provide systems and methods for managing data stored in memory of a device. According to one embodiment, a method for maintaining variable-sized data records in an Internet-of-Things (IoT) device can comprise receiving, by a processor of the IoT device, data for a new record to be stored in a memory of the IoT device and searching, by the processor of the IoT device, a plurality of data frames stored in the memory of the IoT device. The plurality of data frames can be stored in the memory of the IoT device in a circular manner and each data frame can store therein a data record of variable size. Searching the plurality of data frames can comprise locating a head data frame and a tail data frame. Each data frame from of the plurality of data frames can be validated during the searching of the plurality of data frames. In response to locating a valid tail data frame, the data for the new record can be written into a new tail frame for the plurality of data frames.

For example, each data frame of the plurality of data frames can comprise a beginning flag sequence marking a start of the data frame, encoded data for the data record stored in the frame, and an ending flag sequence marking an end of the data frame. In such cases, validating each data frame can comprise finding the data record for the data frame based on the beginning flag sequence and the ending flag sequence and decoding the encoded data for the data record. The decoded data for each data record can comprise a footer for the data record and validating each data frame can further comprise extracting the footer for the data record from the decoded data for the data record. The footer can comprise a field defining a record length for the data record. Validating each data frame can then further comprise reading the record length from the footer and comparing a length of the decoded data record to the record length from the footer. In response to determining, based on comparing the length of the decoded data record to the record length from the footer, that the length of the decoded data record matches the record length from the footer, the data frame can be determined to be valid. In response to determining, based on comparing the length of the decoded data record to the record length from the footer, that the length of the decoded data record does not match the record length from the footer, the data frame can be determined to be invalid.

According to another embodiment, an Internet-of-Things (IoT) device can comprise a processor and a memory coupled with and readable by the processor and storing therein a set of instructions which, when executed by the processor, causes the processor to receive data for a new record to be stored in the memory of the IoT device and search a plurality of data frames stored in the memory of the IoT device. For example, the memory can comprise a flash memory. In some implementations, the flash memory can comprise a NAND flash memory. The plurality of data frames can be stored in the memory of the IoT device in a circular manner and each data frame can store therein a data record of variable size. In such cases, searching the plurality of data frames can comprise locating a head data frame and a tail data frame. The instructions can further cause the processor to validate each data frame from of the plurality of data frames during the searching of the plurality of data frames and, in response to locating a valid tail data frame, write the data for the new record into a new tail frame for the plurality of data frames.

For example, each data frame of the plurality of data frames can comprise a beginning flag sequence marking a start of the data frame, encoded data for the data record stored in the frame, and an ending flag sequence marking an end of the data frame. In such cases, validating each data frame can comprise finding the data record for the data frame based on the beginning flag sequence and the ending flag sequence and decoding the encoded data for the data record. The decoded data for each data record can comprise a footer for the data record and validating each data frame can further comprise extracting the footer for the data record from the decoded data for the data record. The footer can also comprise a field defining a record length for the data record and validating each data frame can further comprise reading the record length from the footer and validating each data frame can further comprise comparing a length of the decoded data record to the record length from the footer. In response to determining, based on comparing the length of the decoded data record to the record length from the footer, that the length of the decoded data record matches the record length from the footer, the instructions can further cause the processor to determine the data frame to be valid. In response to determining, based on comparing the length of the decoded data record to the record length from the footer, that the length of the decoded data record does not match the record length from the footer, the instructions can cause the processor to determine the data frame to be invalid.

According to yet another embodiment, an Internet of Things (IoT) vehicle monitoring device can comprise a processor and a memory coupled with and readable by the processor and storing therein a set of instructions which, when executed by the processor, causes the processor to receive data for a new record to be stored in the memory of the IoT device. The data can comprise one or more parameters related to operation or location of a vehicle in which the IoT vehicle monitoring device is installed. The memory can comprise, for example, a flash memory. In some implementations, the flash memory can comprise a NAND flash memory. The plurality of data frames can be stored in the memory of the IoT vehicle monitoring device in a circular manner and each data frame can store therein a data record of variable size. The instructions can further cause the processor to search the plurality of data frames. Searching the plurality of data frames can comprise locating a head data frame and a tail data frame. The instructions can further cause the processor to validate each data frame from of the plurality of data frames during the searching of the plurality of data frames and, in response to locating a valid tail data frame, write the data for the new record into a new tail frame for the plurality of data frames.

For example, each data frame of the plurality of data frames can comprise a beginning flag sequence marking a start of the data frame, encoded data for the data record stored in the frame, and an ending flag sequence marking an end of the data frame. In such cases, validating each data frame can comprise finding the data record for the data frame based on the beginning flag sequence and the ending flag sequence and decoding the encoded data for the data record. The decoded data for each data record can comprise a footer for the data record and validating each data frame can further comprise extracting the footer for the data record from the decoded data for the data record. The footer can also comprise a field defining a record length for the data record and validating each data frame can further comprise reading the record length from the footer and validating each data frame can further comprise comparing a length of the decoded data record to the record length from the footer. In response to determining, based on comparing the length of the decoded data record to the record length from the footer, that the length of the decoded data record matches the record length from the footer, the instructions can further cause the processor to determine the data frame to be valid. In response to determining, based on comparing the length of the decoded data record to the record length from the footer, that the length of the decoded data record does not match the record length from the footer, the instructions can cause the processor to determine the data frame to be invalid.

### BRIEF DESCRIPTION OF THE DRAWINGS

FIG. 1 is a block diagram illustrating elements of an exemplary environment in which embodiments of the present disclosure may be implemented.

FIG. 2 is a block diagram illustrating elements of an Internet of Things (IoT) device in which embodiments of the present disclosure may be implemented.

FIGS. 3A-3C are block diagrams illustrating exemplary formats for data frames and records used in embodiments of the present disclosure.

FIG. 4 is a flowchart illustrating an exemplary process for using variable sixed record storage according to one embodiment of the present disclosure.

FIG. 5 is a flowchart illustrating additional details of an exemplary process for validating a record according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

Embodiments of the present disclosure provide systems and methods for managing data stored in memory of an Internet-of-Things (IoT) device. Such a device can include, but is not limited to, a vehicle monitoring device which may be connected to a vehicle to collect various operating and/or location parameters from and/or about the vehicle for transmission to one or more servers over one or more wireless communications networks. In such a device, invalid records may occur when a record is only partially written. This can happen due to loss of power to the device, memory communication errors within the device, coding errors, etc. Embodiments described herein are directed to maintaining records within the memory of such a device and detecting these invalid records.

According to various embodiments, and as will be described in greater detail below, frames, which contain data records can be written to a flash memory of the device in a circular fashion. This means that once the flash part has been filled with records, new records overwrite the oldest records(s). New records can be written after and adjacent to the current newest record. Reading and writing records hence involves knowing or finding the current head and tail of the record store, he head being the most recently written record and the tail being the oldest. The head and tail can be initially located through a full search of the flash part. As will be described in detail below, valid frames can be identified based on an actual length of the data record compared to an indication of the expected length of the data record stored in a footer of the data record in memory. This validation approach doesn't require calculating a Cyclic Redundancy Check (CRC) over the data and instead relies on the frame encoding, record length and the fact that erased flash page bytes default to the value 0xFF. Based on the record length field in conjunction with the frame encoding, invalid records can be ignored.

In the following examples, embodiments of the present disclosure are described in the context of an IOT vehicle monitoring device. However, it should be understood that these examples are provided for illustrative purposes only and are not intended to limit the scope of the present disclosure. Rather, embodiments described herein are thought to be equally applicable to other types of IoT or even other types of devices in which efficient and effective memory management is important. Implementation in such devices is considered to be within the scope of the present disclosure.

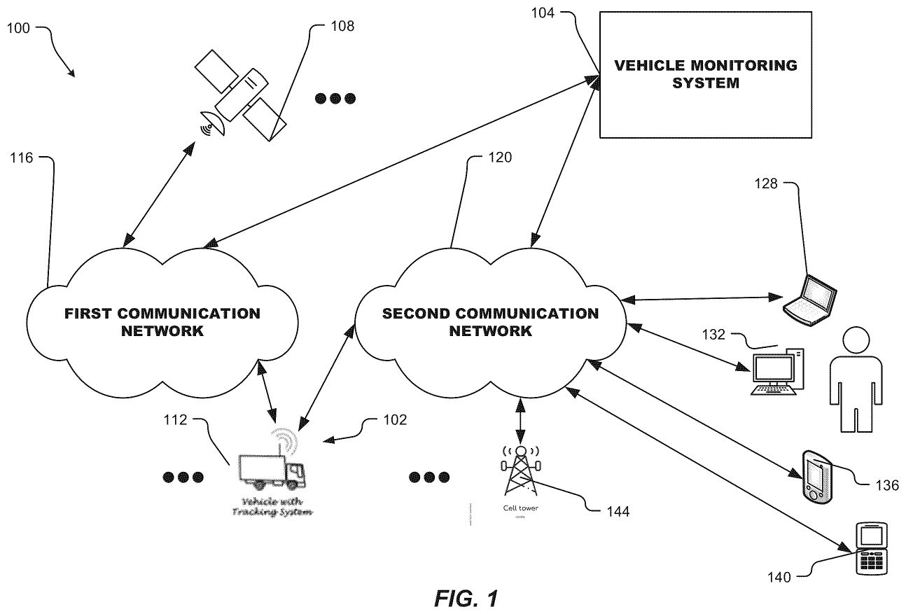

FIG. 1 is a block diagram illustrating elements of an exemplary environment in which embodiments of the present disclosure may be implemented. More specifically, this example illustrates a vehicle monitoring architecture 100, comprising an IoT vehicle monitoring device 102 on a monitored vehicle 112 (shown as a truck), in communication with a satellite navigation system 108 via a first communication network 116 and with a vehicle monitoring system 104 via a second communication network 120, is shown in accordance with embodiments of the present disclosure. The monitored vehicle 112 can be any vehicle, aircraft, ship, trailer, storage container or other cargo, shipment, electronic device such as a smart phone, or other asset. As shown, multiple monitored vehicles 112 can be monitored simultaneously. The vehicle monitoring system 104, in turn, is in communication with the satellite navigation system 108, via the first communication network 116, and one or more computational devices, such as a laptop 128, personal computer 132, personal digital assistant 136 (e.g., a tablet computer), and/or a smart phone 140, of a user 124 via the second communication network 120. The satellite navigation system 108 can be any global or regional satnav system and typically includes not only satellites but also ground stations to monitor and control satellites and receivers to listen for signals from the satellites. The first communication network 116 can be a radio network configured to operate with the satellite navigation system 108 to provide radionavigation-satellite service.

The second communication network 120 may comprise any type of known communication medium or collection of communication media and may use any type of protocols to transport messages between endpoints. The second communication network 120 may include wired and/or wireless communication technologies (as shown by plural base stations 144). The Internet is an example of the second communication network 120 that constitutes an Internet Protocol (“IP”) network comprising computers, computing networks, and other communication devices located all over the world, which are connected through many telephone systems and other means. Other examples of the second communication network 120 include, without limitation, a standard Plain Old Telephone System (“POTS”), an Integrated Services Digital Network (“ISDN”), the Public Switched Telephone Network (“PSTN”), a Local Area Network (“LAN”), a Wide Area Network (“WAN”), a VoIP network, a Session Initiation Protocol (“SIP”) network, a cellular network, and any other type of packet-switched or circuit-switched network known in the art. In addition, it can be appreciated that the second communication network 120 need not be limited to any one network type, and instead may be comprised of a number of different networks and/or network types. The second communication network 120 may comprise a number of different communication media such as coaxial cable, copper cable/wire, fiber-optic cable, antennas for transmitting/receiving wireless messages, and combinations thereof.

Generally speaking, the IoT vehicle monitoring device 102 can collect information regarding operation and/or location of the monitored vehicle 112. This information can include, but is not limited to location information obtained through the first communication network 116 as well as operating parameters of the vehicle. This collected information can be provided by the IoT vehicle monitoring device 102 to the vehicle monitoring system 104 via the second communication network 120. The vehicle monitoring system 104 can in turn make the information available to users of various devices 128, 132, 136, and 140 through the second communication network 120. As will be described below, the IoT vehicle monitoring device 102 can maintain the collected data in memory of the IoT vehicle monitoring device 102 according to embodiments of the present disclosure.

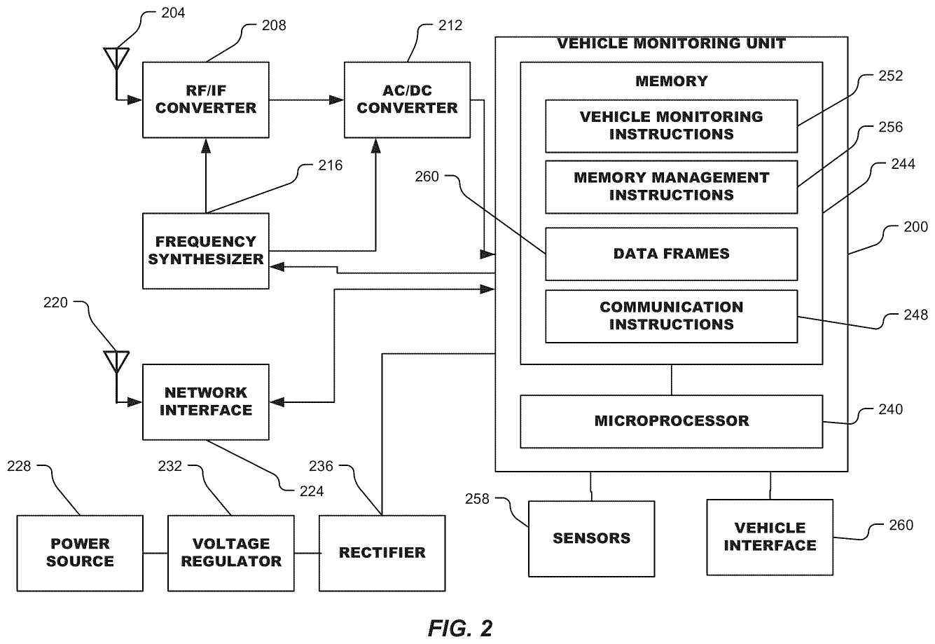

FIG. 2 is a block diagram illustrating elements of an IoT device in which embodiments of the present disclosure may be implemented. More specifically, and as illustrated in this example, the IoT vehicle monitoring device 102 is shown to include a vehicle monitoring unit 200 engaged with a first antenna 204 (such as an RF antenna) to receive signals from and send signals to the satellite navigation system 108 via the first communication network 116 in communication with an RF/IF converter 208, AC/DC converter 212 and frequency synthesizer 216, a second antenna 220 (such as a WiFi antenna and driver circuit, Bluetooth antenna and driver circuit, or a cellular communication antenna and driver circuit) and network interface 224 to receive signals from and send signals to the vehicle monitoring system 104 via the second communication network 120, and a power source 228, voltage regulator 232, and rectifier 236 to supply electrical energy to the vehicle monitoring unit 200.

The signals transmitted from satellite navigation system 108 are received at the first antenna 204. Through the radio frequency (RF) chain, the input signal is amplified by the RF/IF converter 208 to a selected amplitude, and the frequency is converted by the frequency synthesizer 216 to a desired output frequency. The analogue-to-digital converter (ADC) 212 is used to digitize the amplified and frequency-adjusted input signal.

The configuration of the network interface 224 in signal communication with the second antenna 220 may depend upon the IoT vehicle monitoring device 102. Examples of a suitable network interface 224 include, without limitation, an Ethernet port, a USB port, an RS-232 port, an RS-485 port, a NIC, an antenna, a driver circuit, a modulator/demodulator, etc. The network interface 224 may include one or multiple different network interfaces depending upon whether the IoT vehicle monitoring device 102 is connecting to a single (second) communication network 120 or multiple different types of (second) communication networks 120.

The power source 228 may correspond to an internal power supply that provides AC and/or DC power to components of the IoT vehicle monitoring device 102. In some embodiments, the power source 228 may correspond to one or multiple batteries or capacitors or other electromagnetic energy storage devices. Alternatively, or additionally, the power source 228 may include a power adapter or wireless charger that converts AC power into DC power for direct application to components of the IoT vehicle monitoring device 102, for charging a battery, for charging a capacitor, or a combination thereof.

The vehicle monitoring unit 200, in turn, includes a microprocessor 240 and memory 244. In some embodiments, the microprocessor 240 may correspond to one or many microprocessors, CPUs, microcontrollers, Integrated Circuit (IC) chips, or the like. For instance, the processor 604 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the microprocessor 208 may be provided as a microcontroller, microprocessor, Central Processing Unit (CPU), or plurality of microprocessors that are configured to execute the instructions sets stored in memory 244. The memory 244 may include one or multiple computer memory devices that are volatile or non-volatile. The memory 244 may include volatile and/or non-volatile memory devices. Non-limiting examples of memory 244 include Random Access Memory (RAM), Read Only Memory (ROM), flash memory, Electronically-Erasable Programmable ROM (EEPROM), Dynamic RAM (DRAM), etc. The memory 244, while illustrated here as a single unit, may in various implementation comprise two or more different types of memory. In some cases, these different types of memory may additionally, or alternatively include a flash memory such as a NAND flash, for example, in which data collected by the IoT vehicle monitoring device 102 is stored.

The memory 244 may be configured to store the instruction sets depicted in addition to temporarily storing data for the microprocessor 240 to execute various types of routines or functions. The instruction sets can enable interaction with the IoT vehicle monitoring server 200 and real time tracked object location and state of health monitoring. For example, the memory 244 may store therein a set of vehicle monitoring instructions which, when executed by the microprocessor 240, causes the microprocessor 240 to collect information from the vehicle via one or more sensors 258 installed in or on the vehicle, from the vehicle itself, e.g., though a vehicle interface 260 such as an On-Board Diagnostic (OBD) II or similar interface, etc. The data can comprise one or more parameters related to operation or location of a vehicle in which the IoT vehicle monitoring device is installed. A communication instruction set 248 may enable the vehicle monitoring device 102 to exchange electronic communications, either directly or indirectly, with vehicle monitoring system 104.

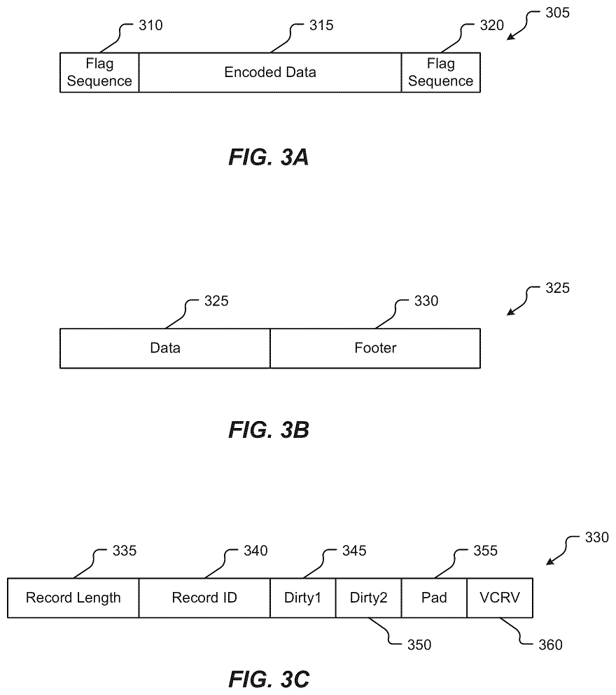

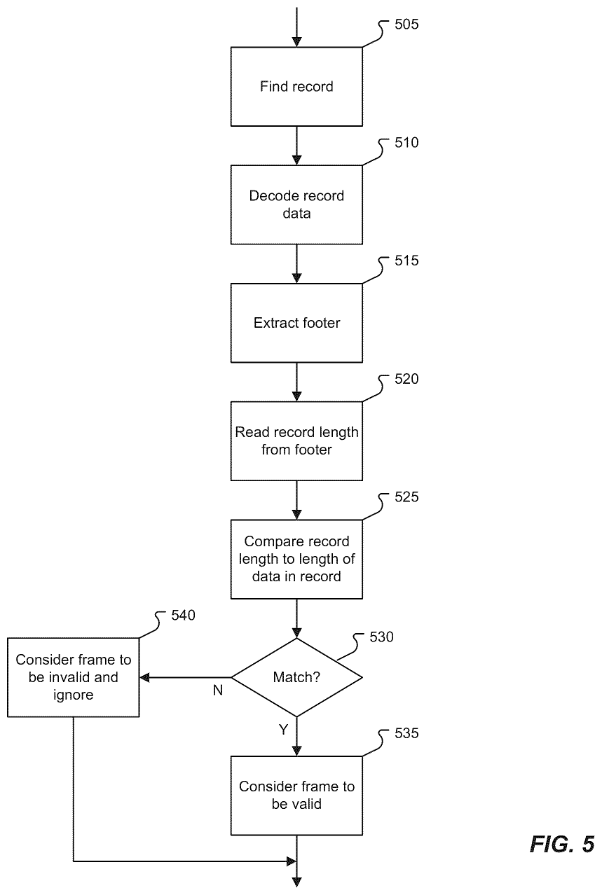

The memory 244 can further store therein a set of memory management instructions 256 which, when executed by the microprocessor 240, causes the microprocessor 240 to store the collected data in a plurality of data frames 260 in memory 244. The plurality of data frames 260 can be stored in the memory 244 of the IoT vehicle monitoring device 102 in a circular manner and each data frame 260 can store therein a data record of variable size. When receiving new data, i.e., from monitoring of the vehicle, the memory management instructions 256 can further cause the microprocessor 240 to search the plurality of data frames 260. Searching the plurality of data frames 260 can comprise locating a head data frame and a tail data frame. The memory management instructions 256 can further cause the microprocessor 240 to validate each data frame from of the plurality of data frames 260 during the searching of the plurality of data frames 260 and, in response to locating a valid tail data frame, write the data for the new record into a new tail frame for the plurality of data frames. Additional details of the content of the data frames 260 will be described below with reference to FIGS. 3A-3C. Similarly, additional details of an exemplary process for validating each data record as may be performed by the microprocessor 240 when executing the memory management instructions 256 will be described below with reference to FIG. 5.

FIGS. 3A-3C are block diagrams illustrating exemplary formats for data frames and records used in embodiments of the present disclosure. More specifically, and as illustrated in the example of FIG. 3A, each data frame 305 can comprise a beginning flag sequence 310 marking a start of the data frame, encoded data 315 for the data record stored in the frame 305, and an ending flag sequence 320 marking an end of the data frame. As illustrated in FIG. 3B, once the encoded data 315 has been decoded, the decoded data 325 for each data record can comprise the data 325 for the record, e.g., data related to the operation and/or location of a monitored vehicle, and a footer 330 for the data record. As further illustrated in FIG. 3C, the footer 330 can further comprise a field 335 defining a record length for the data 325 if the record.

As described herein, the field 335 defining the record length for the data 325 of the record can be used to validate the data frame 305 by comparing a length of the decoded data 325 for the record to the field 335 defining the record length from the footer 330 of the decoded data 325 from the frame 305. If the length of the decoded data 325 for the record matches the length indicated by the field 335 defining the record length from the footer 330 of the decoded data 325 from the frame 305, the data frame can be considered valid. If the length of the decoded data 325 for the record does not match the length indicated by the field 335 defining the record length from the footer 330 of the decoded data 325 from the frame 305, the data frame can be considered invalid.

In some cases, the footer 330 can include any number of other fields 340-360. These fields can include, but are not limited to, a record IDentifier (ID) for the data record stored in the frame 305,
Ryan, can you help me briefly describe each of these, please?
One or more dirty bytes 345 and 350
One or more pad bytes 355
And one or more VCRV bytes 360 (what does this acronym stand for?)

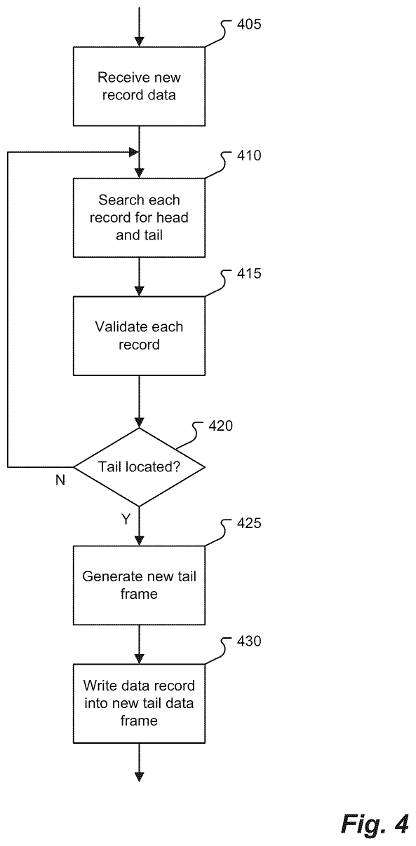

FIG. 4 is a flowchart illustrating an exemplary process for using variable sixed record storage according to one embodiment of the present disclosure. More specifically, this example illustrates a process as may be performed by a processor of an IoT vehicle monitoring device or other IoT device such as described above. As illustrated in this example, maintaining variable-sized data records in an IoT device can comprise receiving 405 data for a new record to be stored in a memory of the IoT device and searching 410 a plurality of data frames stored in the memory of the IoT device. As described above, the plurality of data frames can be stored in the memory of the IoT device in a circular manner and each data frame can store therein a data record of variable size. Searching 410 the plurality of data frames can comprise locating a head data frame and a tail data frame. Each data frame from of the plurality of data frames can be validated 415 during the searching of the plurality of data frames. Details of an exemplary process for validating 415 the data records will be described below with reference to FIG. 5. A determination 420 can be made, during the searching 415 and validating 415 of the records, as to whether a valid tail data frame has been located. In response to determining 420 a valid tail data frame has been located, a new tail data frame can be generated 425 and the data for the new record can be written 430 into the new tail frame for the plurality of data frames.

FIG. 5 is a flowchart illustrating additional details of an exemplary process for validating a record according to one embodiment of the present disclosure. As described above, each data frame of the plurality of data frames stored in the memory of the IoT device can comprise a beginning flag sequence marking a start of the data frame, encoded data for the data record stored in the frame, and an ending flag sequence marking an end of the data frame. As illustrated in FIG. 5, validating each data frame can comprise finding 505 the data record for the data frame based on the beginning flag sequence and the ending flag sequence and decoding 510 the encoded data for the data record. As also described above, the decoded data for each data record can comprise a footer for the data record. Validating each data frame can then further comprise extracting 515 the footer for the data record from the decoded data for the data record. The footer, as also described above, can comprise a field defining a record length for the data of the record. Validating each data frame can then further comprise reading 520 the record length for the data of the record from the footer and comparing a length of the decoded data record to the data length for record length from the footer. A determination 530 can then be made as to whether the length of the decoded data for the record matches the length indicated by the field defining the record length from the footer of the decoded data from the frame.

In response to determining 530, based on comparing 525 the length of the decoded data record to the record length from the footer, that the length of the decoded data for the record matches the length indicated by the field defining the record length from the footer of the decoded data from the frame, the data frame can be determined 535 to be valid. In response to determining 530, based on comparing the length of the decoded data record to the record length from the footer, that the length of the decoded data for the record does not match the length indicated by the field defining the record length from the footer of the decoded data from the frame, the data frame can be determined 540 to be invalid.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for maintaining variable-sized data records in an Internet-of-Things (IoT) device, the method comprising:
receiving, by a processor of the IoT device, data for a new record to be stored in a memory of the IoT device;
searching, by the processor of the IoT device, a plurality of data frames stored in the memory of the IoT device, wherein the plurality of data frames are stored in the memory of the IoT device in a circular manner, wherein each data frame stores therein a data record of variable size, and wherein searching the plurality of data frames comprises locating a head data frame and a tail data frame;
validating, by the processor of the IoT device, each data frame from of the plurality of data frames during the searching of the plurality of data frames; and
in response to locating a valid tail data frame, writing, by the processor of the IoT device, the data for the new record into a new tail frame for the plurality of data frames.

2. The method of claim 1, wherein each data frame of the plurality of data frames comprises a beginning flag sequence marking a start of the data frame, encoded data for the data record stored in the frame, and an ending flag sequence marking an end of the data frame and wherein validating each data frame comprises:
finding the data record for the data frame based on the beginning flag sequence and the ending flag sequence; and
decoding the encoded data for the data record.

3. The method of claim 2, wherein the decoded data for each data record comprises a footer for the data record and wherein validating each data frame further comprises extracting the footer for the data record from the decoded data for the data record.

4. The method of claim 3, wherein the footer comprises a field defining a record length for the data record and wherein validating each data frame further comprises reading the record length from the footer.

5. The method of claim 4, wherein validating each data frame further comprises comparing a length of the decoded data record to the record length from the footer.

6. The method of claim 5, wherein validating each data frame further comprises in response to determining, based on comparing the length of the decoded data record to the record length from the footer, that the length of the decoded data record matches the record length from the footer, determining the data frame to be valid.

7. The method of claim 5, wherein validating each data frame further comprises in response to determining, based on comparing the length of the decoded data record to the record length from the footer, that the length of the decoded data record does not match the record length from the footer, determining the data frame to be invalid.

8. An Internet-of-Things (IoT) device comprising:
a processor; and
a memory coupled with and readable by the processor and storing therein a set of instructions which, when executed by the processor, causes the processor to:
receive data for a new record to be stored in the memory of the IoT device;
search a plurality of data frames stored in the memory of the IoT device, wherein the plurality of data frames are stored in the memory of the IoT device in a circular manner, wherein each data frame stores therein a data record of variable size, and wherein searching the plurality of data frames comprises locating a head data frame and a tail data frame;
validate each data frame from of the plurality of data frames during the searching of the plurality of data frames; and
in response to locating a valid tail data frame, write the data for the new record into a new tail frame for the plurality of data frames.

9. The IoT device of claim 8, wherein each data frame of the plurality of data frames comprises a beginning flag sequence marking a start of the data frame, encoded data for the data record stored in the frame, and an ending flag sequence marking an end of the data frame and wherein validating each data frame comprises:
finding the data record for the data frame based on the beginning flag sequence and the ending flag sequence; and
decoding the encoded data for the data record.

10. The IoT device of claim 9 wherein the decoded data for each data record comprises a footer for the data record and wherein validating each data frame further comprises extracting the footer for the data record from the decoded data for the data record.

11. The IoT device of claim 10, wherein the footer comprises a field defining a record length for the data record and wherein validating each data frame further comprises reading the record length from the footer and wherein validating each data frame further comprises comparing a length of the decoded data record to the record length from the footer.

12. The IoT device of claim 11, wherein validating each data frame further comprises in response to determining, based on comparing the length of the decoded data record to the record length from the footer, that the length of the decoded data record matches the record length from the footer, determining the data frame to be valid and in response to determining, based on comparing the length of the decoded data record to the record length from the footer, that the length of the decoded data record does not match the record length from the footer, determining the data frame to be invalid.

13. The IoT device of claim 8, wherein the memory comprises a flash memory.

14. The IoT device of claim 14, wherein the flash memory comprises a NAND flash memory.

15. An Internet of Things (IoT) vehicle monitoring device comprising:
a processor; and
a memory coupled with and readable by the processor and storing therein a set of instructions which, when executed by the processor, causes the processor to:
receive data for a new record to be stored in the memory of the IoT device, wherein the data comprises one or more parameters related to operation or location of a vehicle in which the IoT vehicle monitoring device is installed;
search a plurality of data frames stored in the memory of the IoT device, wherein the plurality of data frames are stored in the memory of the IoT device in a circular manner, wherein each data frame stores therein a data record of variable size, and wherein searching the plurality of data frames comprises locating a head data frame and a tail data frame;
validate each data frame from of the plurality of data frames during the searching of the plurality of data frames; and
in response to locating a valid tail data frame, write the data for the new record into a new tail frame for the plurality of data frames.

16. The IoT vehicle monitoring device of claim 15, wherein each data frame of the plurality of data frames comprises a beginning flag sequence marking a start of the data frame, encoded data for the data record stored in the frame, and an ending flag sequence marking an end of the data frame and wherein validating each data frame comprises:
finding the data record for the data frame based on the beginning flag sequence and the ending flag sequence; and
decoding the encoded data for the data record.

17. The IoT vehicle monitoring device of claim 16 wherein the decoded data for each data record comprises a footer for the data record and wherein validating each data frame further comprises extracting the footer for the data record from the decoded data for the data record.

18. The IoT vehicle monitoring device of claim 17, wherein the footer comprises a field defining a record length for the data record and wherein validating each data frame further comprises reading the record length from the footer and wherein validating each data frame further comprises comparing a length of the decoded data record to the record length from the footer.

19. The IoT vehicle monitoring device of claim 18, wherein validating each data frame further comprises in response to determining, based on comparing the length of the decoded data record to the record length from the footer, that the length of the decoded data record matches the record length from the footer, determining the data frame to be valid and in response to determining, based on comparing the length of the decoded data record to the record length from the footer, that the length of the decoded data record does not match the record length from the footer, determining the data frame to be invalid.

20. The IoT vehicle monitoring device of claim 15, wherein the flash memory comprises a NAND flash memory.
